(19) United States
(12) Patent Application Publication
(10) Pub. No.: US 2007/0219099 A1
(43) Pub. Date: Sep. 20, 2007

(54) Lubricant For Conveyor Chains For Packaged Products

(76) Inventor: Fabiola Morales Arriaga, Guadalupe (MX)

Correspondence Address: MICHAEL WINFIELD GOLTRY, 4000 N. CENTRAL AVENUE, SUITE 1220, PHOENIX, AZ, 85012, US

(21) Appl. No.: 11/572,414

(22) PCT Filed: Jan. 26, 2006
(86) PCT No.: PCT/MX05/00055

§ 371 Date: Jan. 19, 2007

(30) Foreign Application Priority Data
Jul. 21, 2004 (MX) NL/A/2004/000060

(51) Int. Cl. C07F 7/08; C10L 1/14

(52) U.S. Cl. 508/207; 508/459; 508/561

(57) ABSTRACT

A lubricant for conveyor chains which are used to convey packaged products. For lubrication purposes, the lubricant is applied directly, without being diluted in water, in a non-continuous manner for prolonged periods of time, such as to leave a layer or film on the surface of the conveyor chain. The inventive lubricant consists of a homogenous mixture comprising: one or more silicon fluids, such as emulsified polydimethylsiloxane; one or more fatty acids, such as oleic acid; one or more amines, such as the surface-active product derived from an ethoxylate amine; and water as the aqueous phase, preferably soft water, and, alternatively, a microbicide, preferably a formaldehyde.

### FIELD OF THE INVENTION

The invention relates to a liquid lubricant not diluted in water which is applied directly, producing a lubricant coat whose convenient use is to lubricate, to avoid germ proliferation and not to react with spilled products, with facility materials, as well as the container materials used in packaged products.

Lubricant is particularly applied in conveyor chains, used generally in the industrial sector, for transporting plasticized bottles, plastic, glass containers, as well as metallic cans used to bottle drinks, food or other products susceptible to be packaged.

### BACKGROUND OF THE INVENTION

Nowadays, packaged drinks, food or products, are available in different types of containers such as plasticized containers, plastic, glass bottles, as well as metallic cans, etc., which during their elaboration and filling process it is necessary for the empty and/or full containers to be transported from one place to another through the different industrial process stages they are subject to, via conveyor chains generally made of plastic or stainless steel, which causes a constant friction effect between the conveyor chains and the containers being conveyed, between conveyor chain components, as well as the contact among containers when being conveyed.

Based on this, a non controlled friction effect, result of an inadequate lubrication of conveyor chain installations, can cause unfavorable situations, such as containers tipping over or obstructing each other (even when conveyor chain keeps working), or on the other hand, they can also cause more noise and discontinue container supply or feed to the subsequent process stages, for example in the filling or labeling stages. These situations cause efficiency drops to occur in the process stages, cause an accelerated wear out in conveyor chains and force the engine capacity; all of this due to an inadequate lubrication.

Now, with the purpose of controlling the friction effect, it is common to use lubricants on conveyor chains; these lubricants divide in two main groups:

1. Soap-based lubricants and

2. Fatty amine-based lubricants.

The characteristic and common disadvantage for every one of these lubricant groups, is that to be applied on conveyor chains, they are required to be previously diluted in big quantities of water, in concentrations that go from 0.1% to 1.0% of lubricant being the other 99.0% to 99.9% of water; therefore, the high water consumption results in high operational costs.

Another common disadvantage of both lubricant groups, is its short permanency on conveyor chain surface, i.e. they form a lubricant coat that tends to disappear too fast, therefore, they are required to be constantly or very frequently applied on conveyor chains; this because they are diluted in high water concentrations, among other causes.

Additionally, as to the specific case of soap-based lubricants, these can be applied practically without problems, but they present disadvantages such as its sensibility to water hardness, which causes the lubricant application system nozzles to clog, therefore, they have to be used preferably with softened water and/or use complexing agents in its composition, for example EDTA (tetra-acetic diamine ethylene acid or its salts). Also, the use of these complexing agents provokes an environmental impact since they are little biodegradable.

Another disadvantage of soap-based lubricants is the excessive foam that can spill over the floor, and therefore be an accident risk for personnel, besides giving bad aspect to facility, floors, and conveyed product.

An additional disadvantage, of this type of lubricants, is that they cause biomass and microorganism proliferation in conveyor chains, floors and drainage, which forces to frequent facility cleanup and sanitation.

In relation to the second type of fatty amine-based lubricants, we find the lubricants on polyamines, tertiary or secondary amines, and neutralized primary fatty amine base.

Amine-based lubricants have the additional disadvantage that their lubricant effect is affected if applied on high-speed conveyor chains, so its application is limited to low- and medium-speed conveyor chains.

This type of lubricants do not have the disadvantages of reacting with the water hardness or supporting biomass or microorganism proliferation compared against soap-based lubricants, but because of its composition, they are little biodegradable and also, especially polyamine base lubricants, because of its composition, tend to react with contents of spilled product on conveyor chains.

### SUMMARY OF THE INVENTION

It is therefore an object of the invention to provide a lubricant for conveyor chains for packaged products that eliminates the mentioned disadvantages; in such a way that its application is liquid and directly on the conveyor chains, without the need to previously dilute it in water, to allow the formation of a lasting film or coat on the conveyor chain surface, which prolongs time intervals between applications, lessens friction values between conveyor chains and empty or full containers, it avoids foam formation and reaction to spilled products or materials from containers and the same conveyor chains, additionally having an adequate microbicidal activity.

Additionally, it is also the objective of this invention to provide a lubricant for conveyor chains for packaged products that is biodegradable.

### DESCRIPTION OF THE INVENTION

Lubricant composition for conveyor chains for packaged products and characteristic details are described in the following paragraphs, with the purpose of defining the characteristics and composition of such lubricant without limiting its scope.

Lubricant for conveyor chains for packaged products according to the invention contains components that could consist of multiple components.

Components are individually described below.

Component I

Lubricant for conveyor chains for packaged products contains a component I, which is one or more silicone fluids, whose chemical structure consists of oxygen and silicon atoms alternated between carbon and carbon, which provides the lubricant for bottled product conveyor chains with properties of chemical resistance, lubricity, oxidation stability, null reactivity with organic compounds especially with polymeric components; having as characteristics its low surface tension, excellent water repellence and its good electric properties.

In silicone fluids, we find polydimethylsiloxane emulsions that are preferably used in this current invention for the lubricant composition for conveyor chains for packaged products, especially those that can be applied on plastic conveyor chains in order to penetrate in hard-to-reach areas.

Other silicone fluids that can be used as component I are dimethylsiloxane, alkylsiloxane, fenylsiloxane, chlorosilane as well as silicone emulsions formed of methyldimethylsilicon, alkylsiloxane, arylsiloxane and chlorosilane that because of their chemical characteristics offer the lubricant its properties of easy application, low surface tension, excellent water repellence, high temperature stability, good lubrication besides being used in low concentrations.

Component II

Lubricant for conveyor chains for packaged products contains a component II, which is one or more fatty acids, that is used as an emulsifier and raises lubricant lubricity of this invention, to be used in diverse material containers such as metal, glass, plastic, plasticized bottle, etc.

Fatty acid consists of an alkylic chain with a terminal carboxylic group, being the easiest configuration that of a completely saturated lineal chain. Fatty acids are classified in short, medium and long chain, and are divided in saturated and unsaturated because of their saturation degree, being unsaturated divided in monounsaturated and polyunsaturated.

Lubricant for conveyor chains for packaged products uses fatty acids from 8 to 22 carbon atoms whether they are saturated, unsaturated or substituted, among these we find caprylic acid of 8 carbon atoms, lauric acid of 12 carbon atoms, palmitic acid of 16 carbon atoms, stearic acid of 18 carbon atoms and preferably polyunsaturated fatty acids with 18 carbon atoms or more, such as linoleic acid, linolenic acid and preferably the oleic acid.

Component III

Lubricant for conveyor chains for packaged products contains a component III, which is one or more amines; this is derived from a fatty acid characterized for having alkyl-aliphatic groups of 8 to 22 carbon atoms that have one or more polyethoxylate groups giving it special characteristics such as water solubility and lubricant emulsification of this invention.

Lubricant for conveyor chains for packaged products preferably uses a surface-active product derived from an ethoxylate amine, which has the function of acting as a cationic and it is associated with the molecule fatty portion to provide the lubricant with homogeneity, lubricity and be used as emulsifying and humectant agent for itself.

Among products previously mentioned, we find for example the coconut ethoxylate amine, coconut alkyl ethoxylate amine, alkyl ethoxylate amine of oleic acid, alkyl ethoxylate amine of stearic acid, alkyl ethoxylate amine of fat and soy alkyl ethoxylate amine.

Component IV

As an optional component, the lubricant for conveyor chains for packaged products contains as a component IV that improves the lubricant microbicidal capacity to avoid microorganism proliferation in the lubricant as much as in the conveyor chain.

Among used products for this purpose, we find the aldehyde, triazine, quaternary ammonium compounds, isotiazoline, chloromethylisotiazoline mixes and methylisotiazoline, formaldehyde is used preferably.

Component V

Lubricant for conveyor chains for packaged products contains as a component V water to facilitate the lubricant application in the conveyor chain, as well as to serve as an aqueous phase for dispersion of the other components. Soft water is preferably used for such purpose.

Mix

Lubricant for conveyor chains for packaged products combines components I, II, III, IV and V in the following percent concentrations in weight:
(a) From 10% to 80% of silicone fluid (component I);
(b) From 0.5% to 6% of fatty acid (component II);
(c) From 0.5% to 6% of amine (component III);
(d) From 0.1% to 0.5% of microbicide (component IV) and
(e) From 10% to 80% of water (component V).

In a version of Lubricant for conveyor chains for packaged products of invention, it shows the following contents in percentage concentration in weight:
(a) From 30.0% to 70.0% of emulsified polydimethylsiloxane (component I);
(b) From 2.0% to 5.0% of oleic acid (component II);
(c) From 2.0% to 5.0% of soy alkyl ethoxylate amine (component III);
(d) From 0.1% to 0.5% of formaldehyde (component IV) y
(e) From 19.9% to 59.5% of soft water (component V).

Table 1 shows examples of lubricant composition for conveyor chains for packaged products including the weight percentage for every component:

TABLE 1

| | Weight percentage for every component | | | | | |
|---|---|---|---|---|---|---|
| Compound | Ex. 1 | Ex. 2 | Ex. 3 | Ex. 4 | Ex. 5 | Ex. 6 |
| Emulsified | 60.0 | 30.0 | 60.0 | 70.0 | 60.0 | 40.0 |
| polydimethylsiloxane | | | | | | |
| Oleic acid | 5.0 | 5.0 | 2.0 | 2.0 | 5.0 | 3.0 |
| Soy alkyl ethoxylate | 5.0 | 5.0 | 2.0 | 5.0 | 5.0 | 3.0 |
| amine | | | | | | |
| Formaldehyde | 0.5 | 0.5 | 0.5 | 0.1 | 0.5 | 0.5 |
| Soft water | 29.5 | 59.5 | 35.5 | 19.9 | 29.5 | 53.5 |

Preparation Mode

Lubricant for conveyor chains for packaged products is prepared mixing water first (component V) with the silicone fluid (component I), then stirring it; adding the fatty acid (component II) and amine (component III) slowly in order to avoid lump formation. Finally, adding the microbicide (component IV) to the mix, leaving it stirring for approximately 20 minutes or until the mixture is homogeneous.

Application Mode

Lubricant for conveyor chains for packaged products is applied directly on the chain surface without adding extra water; this is done using preferably a wide plastic brush with nylon bristle (width of around 0.38 mm) which allows an adequate distribution of lubricant along the conveyor chain to form a lasting lubricant coat or film on its surface.

Another form of application is through the use of automatic or manual spray devices to spray the lubricant on the conveyor chain surface.

In both cases, the lubricant is applied directly on the conveyor chain to form a lubricant coat that adheres to the conveyor chain surface for a period of up to 8 hours.

Friction Coefficient Measurement At Laboratory Level

Friction coefficient defined as the strength exerted by containers against the conveyor chain motion divided by the weight of containers held during the laboratory tests in a lubricant dose of 3 to 10 milliliters is of 0.07 to 0.12. The friction coefficient when applying the invention lubricant is obtained, at laboratory level, by using a certain number of full bottles on a conveyor chain to provoke a tension strength, which is measured with a dynamometer. The full bottles are held with a belt and such belt is held to the dynamometer; you proceed to start the conveyor chain after direct application of the lubricant; dynamometer readings are taken every 5 or 10 minutes as required until lubricant is finished.

The friction coefficient is calculated averaging the dynamometer readings, dividing this average by total weight in grams of full bottles.

Based on the previously described composition embodiments of the lubricant for conveyor chains for packaged products, it is contemplated that the modifications of described composition and embodiments, as well as the alternative composition and embodiments, will be considered as evident for an expert person in the art under the description of lubricant for conveyor chains for packaged products. Therefore, it is considered that the claims include said modifications and alternatives that are in the scope of the lubricant of this invention.

1. A premixed lubricant composition for conveyor chains for packaged products, said premixed lubricant composition comprising:
a quantity of silicone fluid;
a quantity of fatty acid;
a quantity of amine; and
a quantity of water.

2. The premixed lubricant composition for conveyor chains for packaged products of claim 1, further including a quantity of a microbicide.

3. The premixed lubricant composition for conveyor chains for packaged products of claim 1, wherein said quantity of silicone fluid includes at least about 10% by weight of the silicone fluid.

4. The premixed lubricant composition for conveyor chains for packaged products of claim 1, wherein said quantity of silicone fluid includes no more than about 80% by weight of the silicone fluid.

5. The premixed lubricant composition for conveyor chains for packaged products of claim 1, wherein said quantity of silicone fluid further comprises a quantity of emulsified polydimethylsiloxane.

6. The premixed lubricant composition for conveyor chains for packaged products of claim 5, wherein said quantity of emulsified polydimethylsiloxane includes at least about 30% by weight of the emulsified polydimethylsiloxane.

7. The premixed lubricant composition for conveyor chains for packaged products of claim 5, wherein said quantity of emulsified polydimethylsiloxane no more than about 70% by weight of the polydimethylsiloxane.

8. The premixed lubricant composition for conveyor chains for packaged products of claim 1, wherein said silicone fluid is selected from a group consisting of dimethylsiloxane, alkylsiloxane, fenylsiloxane, chlorosilane, silicone emulsions formed of methyldimethylsilicon, alkylsiloxane, arylsiloxane, chlorosilane, and combinations thereof.

9. The premixed lubricant composition for conveyor chains for packaged products of claim 1, wherein said quantity of fatty acid includes at least about 0.5% by weight of the fatty acid.

10. The premixed lubricant composition for conveyor chains for packaged products of claim 1, wherein said quantity of fatty acid includes no more than about 6% by weight of the fatty acid.

11. The premixed lubricant composition for conveyor chains for packaged products of claim 1, wherein said fatty acid is from 12 atoms to 22 carbon atoms.

12. The premixed lubricant composition for conveyor chains for packaged products of claim 11, wherein said quantity of fatty acid further comprises a quantity of oleic acid.

13. The premixed lubricant composition for conveyor chains for packaged products of claim 12, wherein said quantity of oleic acid includes at least about 2% by weight of the oleic acid.

14. The premixed lubricant composition for conveyor chains for packaged products of claim 12, wherein said quantity of oleic acid includes no more than about 5% by weight of the oleic acid.

15. The premixed lubricant composition for conveyor chains for packaged products of claim 1, wherein said quantity of amine includes at least 0.5% by weight of the amine.

16. The premixed lubricant composition for conveyor chains for packaged products of claim 1, wherein said quantity of amine includes no more than about 6% by weight of the amine.

17. The premixed lubricant composition for conveyor chains for packaged products of claim 1, wherein said quantity of amine further comprises a quantity of surface-active product derived from an ethoxylate amine.

18. The premixed lubricant composition for conveyor chains for packaged products of claim 17, wherein said surface-active product is selected from a group consisting of a coconut ethoxylate amine, a coconut alkyl ethoxylate amine, an alkyl ethoxylate amine of oleic acid, an alkyl ethoxylate amine of stearic acid, an alkyl ethoxylate amine of fat, a soy alkyl ethoxylate amine, and combinations thereof.

19. The premixed lubricant composition for conveyor chains for packaged products of claim 17, wherein said quantity of surface-active product includes at least about 2% by weight of the surface-active product.

20. The premixed lubricant composition for conveyor chains for packaged products of claim 1, wherein said quantity of surface-active product includes no more than about 5% by weight of the surface-active product.

21. The premixed lubricant composition for conveyor chains for packaged products of claim 1, wherein said quantity of water includes at least about 10% by weight of the water.

22. The premixed lubricant composition for conveyor chains for packaged products of claim 1, wherein said quantity of water includes no more than about 80% by weight of the water.

23. The premixed lubricant composition for conveyor chains for packaged products of claim 1, wherein said quantity of water further comprises a quantity of soft water.

24. The premixed lubricant composition for conveyor chains for packaged products of claim 23, wherein said quantity of soft water includes at least about 19.9% by weight of the soft water.

25. The premixed lubricant composition for conveyor chains for packaged products of claim 23, wherein said quantity of soft water includes no more than about 59.5% by weight of the soft water.

26. The premixed lubricant composition for conveyor chains for packaged products of claim 2, wherein said quantity of microbicide includes at least about 0.1% by weight of the microbicide.

27. The premixed lubricant composition for conveyor chains for packaged products of claim 2, wherein said quantity of microbicide includes no more than about 0.5% by weight of the microbicide.

28. The premixed lubricant composition for conveyor chains for packaged products of claim 2, wherein said quantity of microbicide further comprises a quantity of formaldehyde.

29. The premixed lubricant composition for conveyor chains for packaged products of claim 28, wherein said quantity of formaldehyde includes at least about 0.1% by weight of the formaldehyde.

30. The premixed lubricant composition for conveyor chains for packaged products of claim 1, wherein said quantity of formaldehyde includes no more than about 0.5% by weight of the formaldehyde.

31. In a conveyor chain surface, the premixed lubricant composition for conveyor chains for packaged products of claim 1, applied to the conveyor chain surface.

32. The premixed lubricant composition for conveyor chains for packaged products of claim 31, applied to the conveyor chain surface with a brush fashioned of nylon bristles.
